(19) United States
(12) Patent Application Publication
(10) Pub. No.: US 2005/0056228 A1
(43) Pub. Date: Mar. 17, 2005

(54) Milk delivery system

(76) Inventors: Gerard Grant Coyston, Elie (CA); Donald Michael Coyston, Winnipeg (CA)

Correspondence Address: STITES & HARBISON PLLC, 1199 NORTH FAIRFAX STREET, SUITE 900, ALEXANDRIA, VA, 22314, US

(21) Appl. No.: 10/938,557

(22) Filed: Sep. 13, 2004

(30) Foreign Application Priority Data
Sep. 12, 2003 (CA) 2,439,672

(51) Int. Cl. A01K 5/00

(52) U.S. Cl. 119/77

(57) ABSTRACT

A milk delivery system is disclosed comprising a reservoir, feeding units from which livestock can drink the liquid feed, supply and return lines connecting the reservoir and feeding units, liquid feed pressurizing means, and pressure regulation means on both the supply and return lines to control the liquid feed pressure within the system, such that the pressure differential between the first and last feeding units may be maintained substantially constant. Mixing means are preferably employed in the reservoir, controlled by a PLC processor for automatic intermittent mixing, and a feeding unit configuration is also disclosed employing a push-type omni-directional mushroom valve for animal-actuated operation with low pressure discharge.

### FIELD OF THE INVENTION

The present invention relates to milk delivery systems, and more particularly to milk delivery systems for supplying feed to livestock.

### BACKGROUND

Many livestock producers employ automatic feeding systems for their livestock, sometimes a liquid feed in cases where there are younger animals such as piglets. In such cases, the liquid feed is often a form of milk replacer product, usually a mixture of dry powder and water. The feed may be either a dry milk replacer product or a condensed liquid feed product.

The milk delivery systems presently in use often comprise feeding units connected by pipelines to a reservoir tank, the pipelines providing a generally continuous flow of liquid feed through the system, and the feeding units often include an animal-actuated valve mechanism to begin flow of the liquid feed into the feeding unit for consumption by the animal. In this way, liquid feed is supplied on an as-needed basis to the livestock and it does not become stagnant in the system while waiting for consumption.

Hammer U.S. Pat. No. 4,757,784 is an example of one such system. Hammer discloses a method and means for circulating fluid to livestock, wherein supply lines run from a reservoir tank to feeding units, allowing for continuous liquid feed circulation. However, the supply lines are situated well above the feeding units, relying on gravity flow for the liquid feed to move down to the individual feeding units through separate vertical lines. The result is a system that may become plugged due to the gravity feed reliance and, although the liquid feed circulates through the overhead supply lines, liquid feed within the vertical lines may become stale if the corresponding valve is not regularly activated.

Schuler U.S. Pat. No. 3,285,226 provides another fluid delivery system, wherein gravity feed is utilized. Continuous flow is maintained, and the use of valves is eliminated. However, reliance is placed on individual standpipes and capillary action, where the height of the fluid in the individual feeding unit maintains the fluid within the feeding tube for consumption. This is a system that may work for water supply, but it fails to address the unique problems associated with liquid feed such as milk replacer product which can become stale in supply lines.

Soppe U.S. Pat. No. 5,115,764 teaches a milk delivery system that seeks to address the unique needs of a milk replacer product, employing a pump-driven system that seeks to ensure the liquid feed does not become stale but is continuously circulated. However, Soppe fails to address the problems associated with maintaining liquid feed pressure over significant line lengths and the use of dry product. Specifically, systems such as that disclosed in Soppe can have significant pressure differential between the first and last feeding units along a supply line, resulting in an inappropriately high pressure at the first feeding unit and negligible pressure at the last feeding unit. A very high pressure, in addition to creating waste when the liquid feed splashes out of the feeding unit, can also startle livestock when it shoots out into the feeding unit, causing the animal to be hesitant about feeding. Also, an improper dry powder to water ratio may result due to the lack of sufficient means to control the ratio after the initial mixing, which improper ratio can disturb the sensitive digestive systems of certain livestock, for example, piglets. A circulating system without a means for maintaining a proper powder to water ratio can result in separation of the product from the water, requiring continuous re-mixing which is impractical and therefore almost never done in practice.

### SUMMARY

What is required therefore, is a liquid feed delivery system that maintains substantially consistent and appropriate pressure along the supply line, and preferably also a means for ensuring the proper powder to water ratio after the initial mixing.

According to one aspect of the present invention there is provided an apparatus for supplying liquid feed to livestock comprising:

a reservoir for containing the liquid feed;

a plurality of feeding units from which the livestock can drink the liquid feed;

a supply line leading from the reservoir to the feeding units for passage of the liquid feed;

a return line leading from the feeding units to the reservoir for passage of the liquid feed;

liquid feed pressurizing means for delivering the liquid feed under pressure to the supply line; and

pressure regulation means on the supply line to relieve excess liquid feed pressure between the reservoir and the feeding units by bypassing liquid feed to the reservoir through a bypass line, and pressure regulation means on the return line to restrict flow through the return line and maintain a back pressure in the apparatus, such that the liquid feed pressure differential between the feeding units may be maintained substantially constant.

In existing systems, the pressure differential between the feeding units on a feed line can be significant. In some systems, there are approximately 10 pounds of pressure difference between the first feeding unit and the last feeding unit. The result is an over-pressured ejection of feed at the first feeding unit, startling the livestock and wasting some product through spillage, and an under-pressured filling of the last feeding unit so slow that the livestock lose interest and are not properly nourished. The present invention allows for pressure control of the system resulting in a pressure differential between the feeding units on the order of 1 psi.

In preferred embodiments of the present invention, the liquid feed pressurizing means is a pump employed for circulating the liquid feed through the supply and return lines, and water input means are connected to the reservoir for controlling consistency of the liquid feed in the reservoir by varying the water to powder ratio. Gravity pressurization may also be employed, although this might necessitate a pumped return flow to the reservoir. Liquid level control can be associated with the reservoir, preferably comprising a solenoid valve and a liquid sensor, whereby activation of the liquid sensor causes the solenoid valve to stop supply from the water input means. The return line is preferably fitted with drainage means to drain and clean the system when it is shut down.

Preferred embodiments of the present invention may also include liquid feed mixing means for mixing the feed and water from the water input means. The liquid feed mixing means are preferably situated within the reservoir.

Primary control means may also be employed with the present invention, preferably a PLC processor and control panel, for controlling the liquid feed level control means, the liquid feed mixing means, and the pump means. The PLC processor is preferably capable of being set to automatically run the liquid feed mixing means for intermittent periods.

According to another aspect of the present invention, there is provided a feeding unit for use with an apparatus for supplying liquid feed to livestock, the feeding unit comprising:

a cup from which the livestock can drink the liquid feed;

valve means in the cup which, when actuated by the livestock, open and allow flow of the liquid feed into the feeding unit; and

a line connected to the valve means for delivering the liquid feed to the valve means;

wherein the valve means are submerged in the liquid feed when the cup is full of liquid feed, ensuring that the cup does not overflow through continued actuation of the valve means by the livestock.

The liquid feed preferably discharges from the bottom of the valve means in order to avoid startling the livestock, and the valve means preferably have a push-type omni-directional mushroom valve head. The cup is also preferably provided with a removable, generally cylindrical extension sized to fit around the cup, as discussed in the following.

The present invention, therefore, addresses the problems inherent in the prior art. It maintains a substantially even pressure throughout the system by the use of supply and return pressure regulation and ensures a consistent powder to water ratio through controlled mixing. The feeding unit also provides a valve means that prevents over-filling while directing liquid feed spray away from the animal to prevent startling the animal.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate an exemplary embodiment of the present invention:

FIG. 1 a schematic illustration of the milk delivery system of the present invention;

FIG. 2 is a schematic illustration of an arrangement of feeding units; and

FIG. 3 is an elevational view partially in section of a feeding unit.

### DETAILED DESCRIPTION

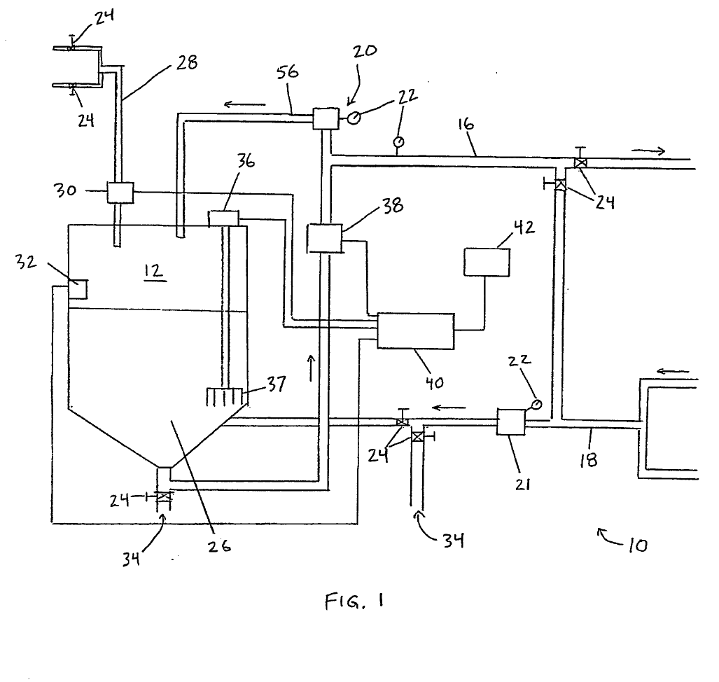

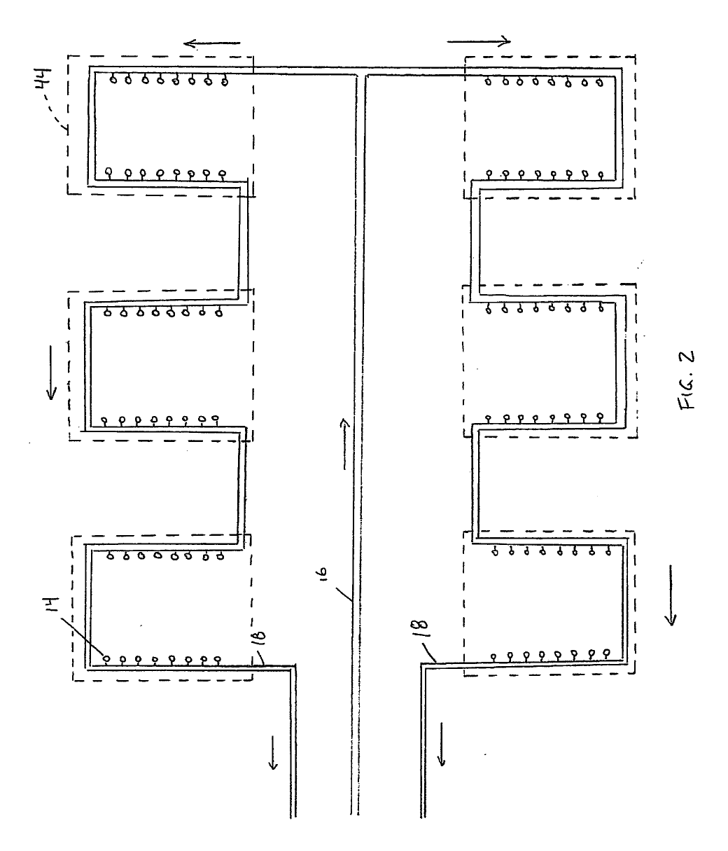

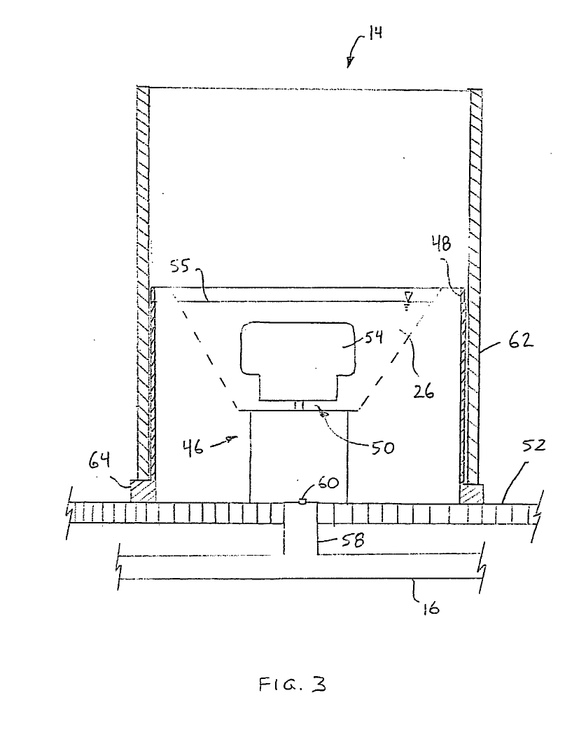

Referring to the accompanying drawings, there is illustrated a preferred embodiment of the milk delivery system of the present invention generally referred to by the numeral 10. The milk delivery system 10 comprises a reservoir 12 for containing the liquid feed 26, feeding units 14 (see FIGS. 2 and 3) from which the animals (not shown) can consume the liquid feed 26, a supply line 16 leading from the reservoir 12 to the feeding units 14, and a return line 18 leading from the feeding units 14 to the reservoir 12. As shown in FIG. 1, the supply and return lines 16, 18 include respective pressure regulators 20, 21 to control the pressure of the liquid feed 26 in the system 10. The pressure regulator 20 on the supply line 16 is a pressure relief valve in a bypass line 56 for diversion of flow to relieve excess pressure to the reservoir 12. A series of gauges 22 and valves 24, as shown in FIG. 1, allow the operator (not shown) to more accurately control operation of the system 10. The reservoir 12 and return line 18 are also fitted with drains 34 so that the system can be drained and cleaned when shut down. To move the liquid feed 26 through the system 10, pump means preferably in the form of an electric diaphragm pump 38 can be employed. The direction of flow of the liquid feed 26 within the system 10 is shown by means of arrows.

The system 10 includes water input means for use in the mixing of dry or condensed milk replacer product. A water input line 28 feeds water into the reservoir 12 for this purpose. A level indicator 32 sends a signal to a PLC processor 40 when the desired maximum liquid feed level is achieved within the reservoir 12, the PLC processor 40 then sending a signal to the solenoid valve 30 causing the solenoid valve 30 to shut off water supply to the reservoir 12.

The PLC processor 40 also controls the pump 38 and the drive motor 36 of a mixer 37 in the reservoir 12, with a control panel 42 allowing the operator to input control information. The mixer 37 is preferably run for an initial five minute period, with automatic intermittent mixing preferably every minute thereafter through operation of the PLC processor 40. This keeps the feed in suspension within the reservoir 12.

The feeding units 14 can be seen in detail in FIG. 3. The cup 48, which can have an inner angled bottom as shown in FIG. 3 in dashed lines, preferably rests on the floor 52 of a farrowing room or crate 44, in the case of piglets. The supply line 16 runs adjacent the feeding unit 14, with an extension 58 connecting to the feeding unit 14. Liquid feed 26 passes therethrough into the valve 46. The feeding unit 14 includes an orifice 60, which can be configured to create back pressure in the extension 58, helping to ensure that the liquid feed 26 in the supply line 16 remains fresh and the liquid feed 26 entering the feeding unit 14 is supplied at a desirable, low pressure. A push-type omni-directional mushroom valve head 54 is preferably employed, as it can be animal-actuated and will rest below the surface level 55 of the liquid feed 26 when the cup 48 is full. An omni-directional mechanism also allows access to the liquid feed 26 without requiring that the animals learn a particular necessary movement of the valve 46. The liquid feed 26 enters the cup 48 by way of a discharge 50, arranged so as to direct the flow of liquid feed 26 downwards in the cup 48 rather than upwards toward the animal as in the prior art. The omni-directional mushroom valve head 54 allows the cup 48 to accommodate young animals such as piglets from birth, and the cup 48 is provided with a removable extension 62 resting on lip 64, which extension 62 effectively increases the depth of the feeding unit 14 so that older piglets can continue to use the system even when increasing in size and feeding aggressiveness.

FIG. 2 illustrates a preferred arrangement of feeding units 14 in the farrowing rooms 44, the farrowing rooms 44 shown in broken line, as well as the direction of flow of the liquid feed 26 within the system 10. As illustrated, the supply line 16 extends to the most remote of the farrowing rooms 44, where it delivers liquid feed 26 to two non-linear return lines 18, the farrowing rooms 44 laid out along the return lines 18. The feeding units 14 are connected sequentially along the return line 18 so that a pressure drop along the return line 18 due to the line length and the numerous elbows in it would result in an excessive pressure at the first feeding units 14 and starving of those further along the return line 18. This is remedied by providing a controlled pressure to the supply line 16 and restricting the flow along the return line 18 to maintain both continuous circulation of the liquid feed 26 and a substantially uniform pressure along the return line 18.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

1. An apparatus for supplying liquid feed to livestock comprising:
a reservoir for containing the liquid feed;
a plurality of feeding units from which the livestock can drink the liquid feed;
a supply line leading from the reservoir to the feeding units for passage of the liquid feed;
a return line leading from the feeding units to the reservoir for passage of the liquid feed;
liquid feed pressurizing means for delivering the liquid feed under pressure to the supply line; and
pressure regulation means on the supply line to relieve excess liquid feed pressure between the reservoir and the feeding units by bypassing liquid feed to the reservoir through a bypass line, and pressure regulation means on the return line to restrict flow through the return line and maintain a back pressure in the apparatus, such that the liquid feed pressure differential between the feeding units may be maintained substantially constant.

2. The apparatus of claim 1 wherein the liquid feed pressurizing means is a pump for circulating the liquid feed through the supply and return lines.

3. The apparatus of claims 1 further comprising water input means connected to the reservoir for controlling consistency of the liquid feed in the reservoir, and liquid level control associated with the reservoir.

4. The apparatus of claim 3 wherein the liquid level control comprises a solenoid valve and a liquid sensor in the reservoir, whereby activation of the liquid sensor causes the solenoid valve to stop supply from the water input means.

5. The apparatus of claim 3 further comprising liquid feed mixing means for mixing the feed and water from the water input means.

6. The apparatus of claim 5 further comprising primary control means for controlling the liquid level control, the liquid feed mixing means, and the liquid feed pressurizing means.

7. The apparatus of claim 6 wherein the primary control means is a PLC processor and control panel.

8. The apparatus of claim 1 wherein the return line is fitted with drainage means.

9. The apparatus of claim 5 wherein water from the water input means is mixed with dry milk replacement product.

10. The apparatus of claim 7 wherein the PLC processor automatically runs the liquid feed mixing means for intermittent periods.

11. A feeding unit for use with an apparatus for supplying liquid feed to livestock, the feeding unit comprising:
a cup from which the livestock can drink the liquid feed;
valve means in the cup which, when actuated by the livestock, open and allow flow of the liquid feed into the feeding unit; and
a line connected to the valve means for delivering the liquid feed to the valve means;
wherein the valve means are submerged in the liquid feed when the cup is full of liquid feed, ensuring that the cup does not overflow through continued actuation of the valve means by the livestock.

12. The apparatus of claim 11 wherein the liquid feed discharges from the bottom of the valve means in order to avoid startling the livestock.

13. The apparatus of claim 11 wherein the valve means have a push-type omni-directional mushroom valve head.

14. The apparatus of claim 11 wherein the cup is provided with a generally cylindrical extension sized to fit around the cup.
